(19) United States
(12) Patent Application Publication
(10) Pub. No.: US 2024/0181914 A1
(43) Pub. Date: Jun. 6, 2024

(54) CHARGING SYSTEM WITH WIND GENERATOR

(71) Applicant: AUDI AG, Ingolstadt (DE)

(72) Inventor: Matthias SCHNEIDER, Schernfeld (DE)

(21) Appl. No.: 18/529,890

(22) Filed: Dec. 5, 2023

(30) Foreign Application Priority Data
Dec. 6, 2022 (DE) 102022132288.2

(51) Int. Cl. B60L 53/60; B60L 50/50; B60L 53/30; B60L 53/50; B60L 53/51; B60L 53/52; B60L 53/53; H02J 3/32; H02J 3/46

(52) U.S. Cl. CPC B60L 53/60; B60L 50/50; B60L 53/30; B60L 53/50; B60L 53/51; B60L 53/52; B60L 53/53; H02J 3/32; H02J 3/46; H02J 2300/24; H02J 2300/28

(57) ABSTRACT

A charging system for charging of electrically powered vehicles is provided, which may comprise at least one charging unit, at least one solar module, and at least one wind generator, the wind generator configured to transform wind flow energy into electric energy and is directly or indirectly connected to the charging unit. The solar module may be situated above the wind generator in the vertical direction and the solar module and the wind generator may be arranged in or on a lifting unit, which may be movable with respect to a receiving unit in at least the vertical direction. A lift mechanism may be include, configured to move the lifting unit relative to the receiving unit. The disclosure furthermore relates to a charging station having a charging system.

### BACKGROUND

### Technical Field

Embodiments of the invention relate to a charging system for charging of electrically powered vehicles, specifically charging systems utilizing a solar module and a wind generator.

### Description of the Related Art

Many distributed charging stations are needed for the building out of electromobility, to make possible charging of electrically powered vehicles. Different types of charging stations exist belonging to the charging infrastructure. Usually, charging stations are connected via a power grid connection to a locally existing electric power grid, by which the electric energy needed for the charging of the vehicles is provided. Furthermore, it is known how to supplement such charging stations with solar modules or wind generators, in order to provide electric energy alternatively or additionally to the power grid connection.

US 2017/0012464 A1 discloses a number of different systems, methods and devices based on the use of solar energy and wind energy for providing electric energy. For example, a charging station is disclosed which comprises solar modules arranged on the roof and a wind generator integrated in a building.

EP1260709A1 discloses a charging station having a nozzle arranged on the roof, which accelerates flow velocity of oncoming wind and furnishes it to a wind generator. The charging station furthermore encompasses at least one solar module.

DE4123750A1 discloses wind turbines for driving a wind generator, wherein flow surfaces are pivoting so as to reduce the air drag during the rotation of the wind turbines.

### BRIEF SUMMARY

The present disclosure provides systems and devices in which electric energy can be provided at least partly as regenerative energy for the charging of vehicles, wherein the components not currently required for the providing of energy are covered and thus protected against environmental factors.

Embodiments include a charging system for charging of electrically powered vehicles, which may include:
at least one charging unit, comprising a connection device or means configured to connect to an electrically powered vehicle and to transfer electric energy from the charging system to the electrically powered vehicle;
at least one solar module, which transforms light energy into electric energy and is connected directly or indirectly to the charging unit; and
at least one wind generator, which transforms wind flow energy into electric energy and is directly or indirectly connected to the charging unit,
wherein the solar module is situated above the wind generator in the vertical direction, and
the solar module and the wind generator are arranged in or on a lifting unit, which is movable with respect to a receiving unit in at least the vertical direction. A lift mechanism may be included, which moves the lifting unit relative to the receiving unit and positions the lifting unit in a wind position such that the wind generator stands out above the receiving unit in the vertical direction and is exposed to the wind. In a calm position of the lift mechanism, the lifting unit may be positioned such that the wind generator is arranged inside the receiving unit, which is configured to cover the wind generator in the calm position.

The charging system may be suitable for the charging of electrically powered vehicles. Alternatively or additionally, the charging system may also be used for the charging of other electric machines, such as work machines, for example. The charging system may comprise at least one charging unit, which allows a connecting of the charging system to an electrically powered vehicle. The connecting device or means configured to connect to the electrically powered vehicle may be, for example, a charging cable with plug connectors configured to connect to the vehicle. In some embodiments, the charging system may encompass multiple charging units. Furthermore, at least one solar module may be provided, which converts the light energy from sunlight into electric energy and provides the electric energy via the charging unit for the charging of an electric vehicle. In addition, at least one wind generator may be provided, although this is used only as needed or temporarily in the charging system for converting wind flow energy. In some embodiments, the solar module may be situated above the wind generator, such that the solar module may not be covered by any other component of the charging system to allow beaming of sunlight onto it. An optimal utilization of sunlight may be assured by this arrangement of the solar module at the very top. The solar module and the wind generator may be arranged on a vertically movable lifting unit. Furthermore, a lift mechanism may be provided, configured to move the lifting unit relative to a receiving unit which is stationary during operation. The lifting unit may be moved up and down between at least two positions in the vertical direction via the lift mechanism. The lift mechanism may position the lifting unit in a wind position such that the wind generator stands out in the vertical direction above the receiving unit. In such embodiments, the wind generator may be exposed to the wind flow in the horizontal direction and may be used for converting wind energy into electric energy. In a calm position, on the other hand, the lift mechanism may position the lifting unit such that the wind generator is situated in the interior of the receiving unit. In such embodiments, the wind generator may be concealed in the calm position and not exposed to the wind. As the lifting unit of a charging system may adopt two positions, the wind generator may be concealed during environmental conditions when little or no wind energy is available and may be protected against environmental factors. However, if suitable environmental conditions are prevailing, such as a suitable wind strength, the lifting unit may be moved into a wind position in which the wind generator converts wind energy into electric energy and provides the electric energy for the operation of the charging system or for the charging of electric vehicles. Furthermore, the charging system may comprise at least one solar module, additionally allowing the conversion of light energy into electric energy. In some embodiments, two different kinds of regenerative energy may be used for providing electric energy, insofar as environmental conditions permit. In some embodiments, the wind generator may be housed and protected inside the receiving unit when not being used for converting wind energy. In this way, dirt and grime may be avoided. This also may prevent animals, such as birds, from getting into the wind generator and the problems associated with this. Furthermore, the outer appearance of the charging system may be improved, since the wind generator is concealed inside the receiving unit when not in use. For example, if the charging system is used in a charging station configured as a building, the appearance of this building may be better adapted to its surroundings and their appearance. The receiving unit may be designed on its outside to conform to the surroundings and their appearance in the calm position may not be disturbed by the technical components of the wind generator.

Some embodiments may include a wind sensor, which is arranged on the receiving unit or the lifting unit, and a control unit, wherein the wind sensor may measure the prevailing wind speed in the surroundings of the system and may relay this to the control unit. The control unit may position the lifting unit by the lift mechanism in the wind position or the calm position depending on this wind strength so relayed. In such embodiments, the charging system may encompass a wind sensor configured to determine the prevailing wind speed. This wind sensor may comprise, for example, an impeller blown by the wind. Other sensor types suitable for detecting the wind speed may also be used. The wind sensor may be exposed adjacent to the receiving unit, such as being arranged above the receiving unit. Furthermore, a control unit may be provided, configured to adjust the position of the lifting unit based on the wind speed as relayed by the wind sensor. The control unit may actuate the lift mechanism, which in turn undertakes the positioning of the lifting unit relative to the receiving unit.

Furthermore, in some embodiments, the control unit may position the lifting unit in the wind position after exceeding a minimum threshold value of the wind strength, wherein wind flows against the wind generator and the wind generator transforms wind flow energy into electric energy. After falling below the minimum threshold value of the wind strength and/or after exceeding a maximum threshold value of the wind strength, the control unit may position the lifting unit in the calm position, wherein the receiving unit shields the wind generator against the wind and covers it at least in the horizontal direction. One or more threshold values for the wind strength may be stored in the control unit and the positioning of the lifting unit may be changed above or below these values. For example, a minimum threshold value may be provided, below which the wind speed is too little, such that an efficient converting into the electric energy by the wind generator is not possible. If the current wind speed is lower than this minimum threshold value, the control unit may position the lifting unit in the protected calm position. If the wind strength increases and exceeds the minimum threshold value, an efficient generating of electric energy by the wind generator may be possible and the control unit may position the lifting unit in the wind position. At very high or heavily fluctuating wind speed, damage may occur to the wind generator. Therefore, a maximum threshold value may be programmed in the control unit, above which the lifting unit may be moved once again to the calm position in order to protect the wind generator. The threshold values may be individually adapted. Furthermore, a manual regulation of the position may be provided, in which the user may adjust the position of the lifting unit regardless of the wind strength. This may be useful, for example, for a servicing of the wind generator.

In some embodiments, the receiving unit may at least partly enclose the lifting unit when viewed from above and/or in the calm position, the lifting unit may only stand out partly or not at all in the vertical direction above the receiving unit. In some embodiments, the receiving unit may surround the lifting unit partially or entirely in the circumferential direction about a vertical axis. Furthermore, in some embodiments, the lifting unit with the wind generator in the calm position may be concealed inside the receiving unit and may extend only for a portion or not at all beyond the receiving unit in the vertical direction. In such embodiments, the wind generator may be protected and arranged inside the receiving unit, not visible from the outside, at least in the calm position. In the wind position, however, the wind generator may be freely accessible and not surrounded by the receiving unit and may optimally convert wind energy into electric energy.

In some embodiments, the lifting unit may be mounted rotatably to the receiving unit in a horizontal plane, at least in the wind position, and a turning mechanism may adjust the rotation position of the lifting unit relative to the receiving unit according to the currently prevailing wind direction or the direction in which the sun is presently located. In such embodiments, the rotary positions of the lifting unit in the horizontal plane may be changed. The wind generator may be optimally oriented to the prevailing wind direction and maximize its efficiency. Alternatively, the lifting unit on which the solar module is arranged may be oriented optimally to the current position of the sun. The rotatability of the lifting unit may be allowed by a turning mechanism, configured to move and position the lifting unit in a horizontal plane relative to the receiving unit. The turning mechanism may be integrated in the lift mechanism and may be electrically or hydraulically operated, for example. The control and regulation of the turning mechanism may rely on sensor signals of an additionally provided wind direction sensor and/or a sunlight sensor. The signals of these sensors may be evaluated by the control unit and the turning mechanism may be actuated based on these signals, such that the lifting unit takes up a rotary position with optimal yield of electric energy.

Furthermore, in some embodiments, the system includes that multiple wind generators, multiple solar modules, and/or a battery storage for storing of electric energy, and/or at least one power grid connection is provided, configured to connect the system to an electric power grid and is connected directly or indirectly to the charging unit. In some embodiments, multiple solar modules and/or multiple wind generators may be provided at the charging system. In such embodiments, the production of regeneratively harvested energy may be increased. Multiple wind generators or multiple solar modules may be oriented in different ways, such that regenerative energy may be provided under different environmental conditions. A battery storage may be used to temporarily store the energy produced by the solar module and the wind generator and may employ this energy for the operation of the charging station or for charging of electrically operated vehicles. A power grid connection may allow a secure energy supply even when neither the solar module nor the wind generator can provide electric energy. Furthermore, an inverter may be provided, configured to feed electric energy to the power grid when sufficient electric energy is provided by the solar module and the wind generator and there is no need for electric energy to charge vehicles. The charging unit may be connected directly or indirectly to the battery storage and/or power grid connection.

In some embodiments, the receiving unit may be connected to a base unit, wherein the receiving unit may be situated above the base unit in the vertical direction. The receiving unit may stand out at least for a section above the base unit in the horizontal direction and the charging unit may be arranged on or in the base unit. In such embodiments, a base unit may be provided, configured to carry the receiving unit and the lifting unit. In some embodiments, the base unit may be connected to the floor beneath the charging system. The receiving unit may extend in the horizontal direction above the base unit such that a protected space is present next to the base unit and beneath the receiving unit, which may be shielded from weather factors such as rain and sunlight by the receiving unit and the lifting unit above it. This space may be used for the parking of electrically powered vehicles being charged by the charging system. The charging unit may be arranged on a vertically running side wall of the base unit and easily accessible from the protected space. A large, horizontally oriented surface may be provided on the lifting unit, which may be used for the mounting of multiple solar modules and/or multiple wind generators.

In some embodiments, the lift mechanism may be electrical or hydraulic in design and may be situated inside the receiving unit and/or the base unit in the calm position. The lift mechanism may be hydraulically driven, such that electric energy generated in the charging system may be used for the movement between the wind position and the calm position of the lifting unit. In some embodiments, a hydraulic pump may be electrically driven and may provide one or more hydraulic cylinders in the lift mechanism for the movement of the lifting unit. In some embodiments, the turning mechanism for the lifting unit may include a hydraulic pump, which may be electrically driven and may provide one or more hydraulic cylinders in the turning mechanism. The lift mechanism may be arranged in a protected manner inside the receiving unit and/or the base unit. In such embodiments, the risk of damage to the lifting unit may be reduced and the lifting unit may hardly be visible from outside the charging system, and therefore, does not disturb the outer appearance of the charging system.

The present disclosure also provides a charging station for charging of electrically powered vehicles, which may comprise at least one charging system according to one of the previously described embodiments, wherein the charging system may be fastened to a geostationary base or to a movable platform. A charging system may be integrated in a charging station, providing electric energy, for example, for the charging of electrically powered vehicles. The charging station may encompass further subassemblies or components, besides the charging system. For example, the charging station may be configured as a building, which may be connected to the ground as geostationary, i.e., an immovable manner. In some embodiments, the charging system may be constructed on a movable platform, such as a trailer, and may be set up in different locations. The charging station may have the advantage that it provides at least partly regeneratively generated electric energy, while subassemblies or components of the charging system which are not needed may be protected inside the charging station.

In some embodiments, the charging system of the charging station may be integrated in a building and the power grid connection is connected to a locally existing electric power grid. In such embodiments, the charging station may be fixed in location and connected to the locally existing electric power grid. The electric power grid may assure an uninterrupted supply of electric energy via the power grid connection. In addition, electric energy may be provided regeneratively through the solar module and/or the wind generator when environmental conditions are suitable. A charging station constructed on a movable platform may be connected to a locally present electric power grid in temporary manner via the power grid connection.

Features, effects, and benefits which are disclosed in connection with the charging system may also be used in connection with the charging station. The same holds, conversely, for features, effects and benefits which are disclosed in connection with the charging station, may also be used in connection with the charging system.

### BRIEF DESCRIPTION OF THE SEVERAL VIEWS OF THE DRAWINGS

FIG. 1 shows a schematic view a charging system in a wind position.

FIG. 2 shows a schematic view of the charging system from FIG. 1 in a calm position.

### DETAILED DESCRIPTION

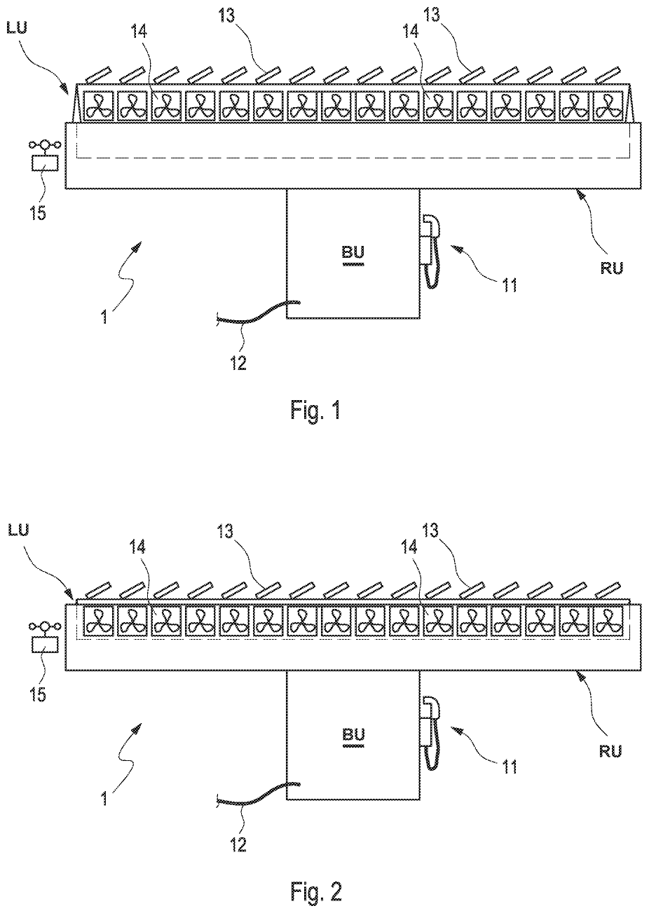

FIG. 1 shows, in a schematic view, a charging system 1 in a wind position. The charging system 1 may comprise multiple solar modules 13 arranged at the very top in the vertical direction, being oriented at an angle of around 30° to the horizontal plane. Multiple wind generators 14 may be arranged beneath the solar modules 13. The illustrated embodiment shown of the wind generators 14 comprises a rotor, which turns about a horizontally oriented axis of rotation under a flow of the wind. In other embodiments, a wind generator 14 may be used whose rotor turns above a vertically oriented axis of rotation. In some embodiments, wind generators 14 of different designs may be combined with each other. The wind generators 14 and the solar modules 13 may be fastened to a lifting unit LU. The lifting unit LU may be formed, for example, by a framework of steel tubes. The lifting unit LU may be configured to be movable relative to the receiving unit RU. The receiving unit RU may be situated such that a portion is positioned beneath the lifting unit LU and completely encloses the lifting unit LU from above when viewed from above. The receiving unit RU may be coupled to a base unit BU arranged beneath it. In the embodiment shown in FIGS. 1 and 2, the receiving unit RU may extend in the horizontal direction about and beyond the entire base unit BU. In the embodiment shown in FIGS. 1 and 2, the charging system 1 may have a mushroom shape and the projecting receiving unit RU forms a kind of roof structure, which may be set upon the base unit BU. A space protected against weather factors from above may be formed beneath the receiving unit RU, adjacent to the base unit BU, which may be used to accommodate electrically powered vehicles which are connected to one or more charging units 11 for their charging. One such charging unit 11 is shown, for example, at the right side of the base unit BU. The charging unit 11 may comprise a pull-out charging cable, the end of which may include a plug connector for connection to an electrically powered vehicle. Since the charging station 11 may be configured to be protected underneath the receiving unit RU, the electrically powered vehicle may be connected to the charging unit 11 while protected against weather factors. In some embodiments, multiple charging units 11 may be arranged around the base unit BU. At the lower end of the base unit BU there may be a power grid connection 12, configured to connect the charging system 1 to a local electric power grid and to provide additional electric energy for the charging of vehicles. To the left and next to the receiving unit RU in FIGS. 1 and 2 is a wind sensor 15, which may be connected to the receiving unit RU. This wind sensor 15 may be provided to measure the currently prevailing wind strength or wind speed and to relay this to a control unit (not shown). The wind sensor 15 may also be connected to the receiving unit RU or the lifting unit LU in other places. For example, the wind sensor 15 may be arranged above the solar modules 13. In FIG. 1, the charging system 1 is shown in a condition in which the lifting unit LU is situated in the wind position. In the wind position, the lifting unit LU with the wind generators 14 arranged thereon may extend beyond the upper edge of the receiving unit RU, such that the wind generators 14 are visible and freely accessible to oncoming wind from the horizontal direction. Inside the receiving unit RU may be a lift mechanism, which may be connected both to the receiving unit RU and to the lifting unit LU. The lift mechanism may enable a movement of the lifting unit LU relative to the receiving unit RU in the vertical direction by providing a guidance and a propulsion for the movement. This propulsion may be formed, for example, by an electric motor or by one or more hydraulic cylinders. The depicted wind position of the lifting unit LU may be adjusted by the lift mechanism when the wind speed, as determined by the wind sensor 15, lies above a minimum threshold value at which the wind generators 14 can profitably convert wind energy into electric energy. If the currently prevailing wind speed lies below this minimum threshold value, the wind generators 14 may not provide any significant electric energy. In such configurations, the lift mechanism, controlled by the control unit, may move the lifting unit LU into the calm position, such that the wind generators 14 are retracted into the interior of the receiving unit RU and protected there. This calm position is shown in FIG. 2. In some embodiments, the lifting unit may be rotatable not only in the vertical direction, but also in a horizontal plane relative to the receiving unit RU. In such embodiments, a turning mechanism may be provided, configured to orient the lifting unit LU such that the wind generators 14 are oriented optimally to the prevailing wind direction or the solar modules are oriented optimally to the current sun position. The turning mechanism can be integrated in the lift mechanism or it can form together with this a common subassembly.

FIG. 2 shows, in a schematic view, the charging system 1 from FIG. 1 in the calm position. In FIG. 2, the same embodiment of a charging system 1 is shown as in FIG. 1. Thus, for FIG. 2, reference is also made to the description of FIG. 1, which also holds for FIG. 2. The difference between FIG. 2 and FIG. 1 is the relative position of the lifting unit LU relative to the receiving unit RU. In FIG. 2, the lifting unit LU is situated in the calm position, in which the wind generators 14 are arranged inside the receiving unit RU. All the wind generators 14 may be located in the interior, beneath the upper edge of the receiving unit RU, and thus not visible, when viewed from the horizontal direction. For a better understanding, the side of the receiving unit RU facing toward the viewer is shown transparent in FIG. 2. In the calm condition shown in FIG. 2, the receiving unit RU protects the wind generators 14 when these are not being used for converting of energy. Hence, dirt and grime, animals, or the like are prevented from getting in during a state in which the wind generators 14 are not being used. In the embodiment shown in FIG. 2, however, the solar modules 14 in the calm position are arranged above the receiving unit RU and on the upper edge of the charging system 1, such that they can have sunlight shining on them without being covered by other components. The depicted calm position of the lifting unit LU may be implemented during low wind strength or during very high wind strength, when there may be a danger of the wind generators 14 being damaged by excessive wind strength.

German patent application no. 10 2022 132288.2, filed Dec. 6, 2022, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A charging system for charging of electrically powered vehicles, comprising:
at least one charging unit, comprising a connection device configured to connect to an electrically powered vehicle and configured to transfer electric energy from the charging system to the electrically powered vehicle;
at least one solar module, configured to transform light energy into electric energy and connected directly or indirectly to the charging unit; and
at least one wind generator, configured to transform wind flow energy into electric energy and directly or indirectly connected to the charging unit,
wherein the solar module is situated above the wind generator in the vertical direction, and
wherein the solar module and the wind generator are arranged in or on a lifting unit, the lifting unit configured to be movable with respect to a receiving unit in at least the vertical direction, the lifting unit configured to move relative to the receiving unit by a lift mechanism and to be positioned in one of a wind position, such that the wind generator stands out above the receiving unit in the vertical direction and is exposed to the wind, and a calm position, such that the wind generator is arranged inside the receiving unit, the receiving unit, the receiving unit configured to cover the wind generator in the calm position.

2. The charging system according to claim 1, further comprising a wind sensor arranged on the receiving unit or the lifting unit and a control unit, wherein the wind sensor is configured to measure prevailing wind speed in surroundings of the system and to relay the prevailing wind speed to the control unit and the control unit is configured to position the lifting unit by the lift mechanism in the wind position or the calm position depending on the prevailing wind speed relayed.

3. The charging system according to claim 2, wherein after exceeding a minimum threshold value of the wind strength, the control unit is configured to position the lifting unit in the wind position, wherein when in the wind position, wind flows against the wind generator and the wind generator is configured to transform wind flow energy into electric energy, and after falling below the minimum threshold value of the wind strength and/or after exceeding a maximum threshold value of the wind strength, the control unit is configured to position the lifting unit in the calm position, wherein when in the calm position, the receiving unit is configured to shield the wind generator against the wind and to cover the wind generator at least in the horizontal direction.

4. The charging system according to claim 1, wherein the receiving unit at least partly encloses the lifting unit when viewed from above and/or when in the calm position, the lifting unit only extends partly in the vertical direction above the receiving unit or does not extend in the vertical direction above the receiving unit.

5. The charging system according to claim 1, wherein the lifting unit is mounted rotatably to the receiving unit in a horizontal plane at least when the lifting unit is in the wind position, and a turning mechanism is configured to rotate the rotation position of the lifting unit relative to the receiving unit according to the currently prevailing wind direction or the direction in which the sun is presently located.

6. The charging system according to claim 1, wherein further comprising multiple wind generators, multiple solar modules, a battery storage for storing of electric energy, and/or at least one power grid connection, the at least one power grid connection configured to connect the system to an electric power grid and is connected directly or indirectly to the charging unit.

7. The charging system according to claim 1, wherein the receiving unit is connected to a base unit, wherein the receiving unit is situated above the base unit in the vertical direction, the receiving unit stands out at least partially above the base unit in the horizontal direction, and the charging unit being arranged on or in the base unit.

8. The charging system according to claim 7, wherein the lift mechanism is electrical or hydraulic and is situated inside the receiving unit and/or the base unit when the lifting unit is in the calm position.

9. A charging station for charging of electrically powered vehicles, comprising at least one charging system according to claim 1, wherein the charging system is coupled to a geostationary base or to a movable platform.

10. A charging station according to claim 9, wherein the charging system is integrated in a building and the power grid connection is connected to a locally existing electric power grid.
